(19) United States
(12) Patent Application Publication
(10) Pub. No.: US 2024/0078985 A1
(43) Pub. Date: Mar. 7, 2024

(54) Sonorous Metal Chordophone Soundboards

(71) Applicant: Mark Fisher, London (CA)

(72) Inventor: Mark Fisher, London (CA)

(21) Appl. No.: 17/903,305

(22) Filed: Sep. 6, 2022

(51) Int. Cl. G10D 1/08; G10D 3/22

(52) U.S. Cl. CPC G10D 1/085; G10D 3/22

(57) ABSTRACT

Musical instruments (e.g., chordophones) may comprise sonorous metal resonant body (e.g., soundboard) die castings. Embodiments may include: hollow body soundboards with integrally cast auxiliary structures, which may, for example, include internal pockets for accommodating damping inserts; as well as damping inserts for use therein. Embodiments may also include acoustics-modulating as-cast soundboards, which may relate to applied-pressure-mediated and/or active cooling-mediated as-cast relative densities and/or refined grain sizes with associated metallurgical acoustic modulations and associated methods.

### FIELD OF THE INVENTION(S)

The present invention relates to musical instruments having acoustically resonant soundboards and is particularly impactful in relation to soundboards for harmonic instrument timbre, as for example in the case of stringed musical instruments, such as chordophones. Examples of such chordophones include plucked, strummed, picked, or bowed stringed instruments such as violins, mandolins, but especially guitars, (and particularly, hollow bodied instruments including both acoustic and electric guitars, and especially hollow-bodied instruments with thin-walled soundboards) and die cast sonorous metal soundboards thereof.

### BACKGROUND

Musical instruments, and in particular resonant bodies thereof, (esp. sound boards for chordophones), traditionally employ tone woods to contribute to the desired overall timbral qualities of the musical instrument. In chordophones, by way of example, tone woods form part of an acoustic wave propagating circuit in which a musician's manipulation of vibrating strings transfers acoustic waves into a resonant body. Tone woods, however, are inherently prone to, (and problematic because of) organic variabilities of various types, degrees, and incidence. Tone wood variation complicates material selection and even impacts the available quality, leading to an increased need for expertise relating to the selection of tone woods and their contribution to the musical characteristics (e.g., timbre) of each instrument. The result, from a practical point of view, is a problem which continues to impact on a craftsman's ability to controllably replicate tone wood based musical instrument qualities. Accordingly, the problematic nature of tone wood materials continues to be nothing short of the stuff of legends in the musical instrument crafting art.

### SUMMARY OF THE INVENTION(S)

The inorganic nature of metal has sometimes been promoted as a less problematic alternative to tone wood materials. This notion appears to be primarily related to the relatively greater isotropy presumptively associated with metal materials in general. A metal material's per se contribution to an instrument's metallurgical timbre, however, generally falls outside of a musical instrument craftsman's control, although some flexibility may arise in alloy selections. Otherwise there remain limitations on a craftsman's opportunity to exercise control over a metal's contribution to musical timbre. While diverse alloys having differing constituencies may be available, they are specifically constituted for industrial purposes and generally not with the intention of meeting musical applications. Moreover, for wrought metals the machining of a foundry billet (or the like) does little to affect the timbral quality of the wrought metal per se. Similarly, forging has limited application to the production of wrought metal resonant bodies of musical instruments, and in some cases is of no practical application at all.

Also generic die casting processes are subject to variabilities which are analogous to the same problems which arise in connection with tone woods. As a result, real-world commercial examples of metal musical instrument resonant bodies have employed forging (where possible in the case of gamelan and other idiophone instruments such as bells or the like); or, been machined from large billets of mill wrought billets as for example in the case of Fender American Standard Aluminium Limited Stratocaster guitars.

Aspects of the present invention relate to selection and control of as-cast musical instrument metal die casting's affected metallurgy and its associated timbral qualities. An aspect hereof is to bring the timbral contribution of that constituent as-cast metallurgy under some corresponding measure of a musical instrument craftsman's selective control without necessitating substantial post-casting remediation.

Aspects hereof may variously include:
Musical instrument soundboards of sonorous metal die castings with integrally cast acoustically functional auxiliary structures, and in particular: internal soundboard-dependant walls, and especially ones thereof functioning as acoustic-coupling intermediates between the soundboard proper and damping inserts installed in association therewith;
Musical instrument damping inserts useful in association with soundboards hereof—and particularly in combinations with auxiliary acoustically functional pocket structures defined by internal-soundboard-dependant walls of the abovementioned metal soundboard die castings; and,
Musical instrument soundboards of sonorous metal die castings having as-cast metallurgy associated with acoustic modulation of an instrument's musicality;
   and various combinations thereof.

More particularly, soundboard die castings hereof may include integrally cast auxiliary structures wherein the acoustic significance of the as-cast integrated (i.e., monolithic) casting is related to reducing acoustic wave propagation interference (e.g., the amount of signal reflection at interfaces between the soundboard proper and such auxiliary structures. Absent the integrated casting hereof, the alternative use of adhesives, welds or mechanically fastened interfaces and the associated acoustic interferences those may introduce into the musical instrument's vibrational circuit may have an adverse or at least unintended impact on the instrument's musicality. Machining, as an alternative, entails substantial material costs/waste and production disadvantages.

Also, damping inserts are contemplated herein for selective damping of soundboards in a musical instrument's circuit—and more particularly for use as pocket inserts in combination with soundboards having integrally cast auxiliary structures comprising pockets for receiving such inserts. Their inclusion may advantageously provide for user-selected mediation of a raw soundboard's acoustical character (i.e., using facilitated selective impedance matching and mismatching through diverse placements of dampener inserts within such pockets).

Furthermore, aspects hereof may include acoustically modulated as-cast sonorous metal sound board die castings whose as-cast metallurgy is characterised by:
stratified cross-sections having differentiated grain size distributions for selectively attenuating acoustic waves channeled along respective strata of the soundboard;
and/or, as-cast pressure-mediated metallurgies which may provide acoustically modulated soundboards having respective as-cast pressure-mediated and/or cooling-mediated metallurgies associated with a soundboard's as-cast relative density or grain surface area, each with their associated acoustic modulations.

These and other aspects of the invention(s) relate to the acoustic waves of vibrational energy being constructively and destructively conditioned, muted and exaggerated through absorption, reflection, directed and redirected propagation, etc., and thereby affecting the modification of frequencies, amplitudes, sustains and overall instrumental timbre, color and the like which are ultimately transmitted from the musical instrument. For example, in the case of a chordophone, string vibrations are variously internally directed, redirected, absorbed and reflected within a soundboard in particular, (as well as the instrument chassis at large), until the string energy is picked-up/transmitted from the instrument as music.

Aspects hereof may result in facilitating design, manufacture and quality for affecting and/or controlling variations in the acoustical impedance characteristics of a musical instrument soundboard, along with concomitant effects on the raw soundboard's musicality.

### INTRODUCTION TO THE DRAWING(S)

FIG. 1 of the appended drawings is a depiction of a design of an electric guitar embodiment according to aspects hereof, and comprising a sonorous metal resonant body (including the sound board thereof with a single pickup mounting);

FIG. 2 depicts and alternate embodiment with a double pickup mounting;

FIG. 3 is a perspective view of the front face of an electric guitar hollow-bodied resonant body die casting in accordance with aspects of the invention(s) hereof;

FIG. 4 is a plan view of a rear wall adapted for enclosing the back of the resonant body depicted in FIG. 3;

FIG. 5 is a perspective interior view of the die casting shown in FIG. 3;

FIG. 6 is a calculated wavelength chart projecting wavelengths for guitar fundamentals associated with sonorous aluminum alloy useful in die castings according to the present invention, with the wavelengths corresponding to various densities and associated metallurgical impedance and elasticity properties;

FIG. 7 is a graphical representation of the calculated impedance estimates related to FIG. 6, over the range of injection pressure mediated (lower curve) and cavity plus injection pressure mediated (upper curve) impedances;

FIG. 8 is similar to FIG. 7, but depicts instead an aspect of the elasticity of the die casting metal over the same ranges of applied pressure mediated modulations;

FIG. 9 is a graphical interpolation of die casting metal density corresponding to a range of pressure mediated metallurgies;

FIG. 10 is a cross sectional schematic representation of a thin wall section of a die casting illustrating projected thermal grain refinement appearances; and,

FIGS. 11a and 11b, respectively depict a plan interior view of and a sectional view though, the interior of the hollow resonant body interior of an embodiment according to the present invention, depicting the combination thereof with damping inserts engaged within integrally cast soundboard pockets.

FIG. 12 is a partial cutaway view of a damping insert per FIGS. 11a and 11b, depicting the laminar cross-structure thereof.

### REFERENCE NUMERALS

Resonant body 1
Soundboard 2
Soundboard surrounding body side wall 2a
Recesses 3
Neck mounting recess 3a
Internal wall structures 4
Pockets 5
Damping inserts 6
Plys 7, 8, 9, 10
Wood grain orientations 7a, 8a, 9, and 10a
Damping insert edge 11
Rear panel 12
Thin wall cross-section 13
Peripheral layers 13a and 13b
Core layer 14

### DETAILED DESCRIPTION(S)

Aspects of the invention(s) relate to musical instrument constructions and in particular to the quality of sound resulting therefrom. These may variously include aspects which relate to acoustic materials, combinations thereof with musical instrument resonant bodies (e.g., soundboards in particular) and musical instruments comprising the same, as well as musical instruments and/or accessories and parts and/or kits related thereto.

Musical instrument resonant bodies may relate to: aerophones, (which rely on an instrument-defined vibrating air column for sound creation such as flutes, clarinets and didgeridoos etc.; membranophones (e.g., drums and other stretched membrane instruments); or idiophones (and particularly pitched idiophones such as xylophones or the like.

More significantly however, the present invention(s) relate(s) to musical instrument resonant bodies having sound boards, and even more particularly, to chordophone resonant bodies (e.g., resonant bodies of tensioned string instruments for which strings are plucked, bowed or strummed (e.g., violins, mandolins, guitars) or hammered, and especially to sound boards thereof.

Musical instruments produce complex sound signals for a listening audience—and much more so in the case of instruments classed as (perfectly or nearly) harmonic instruments—i.e., those having characteristic overtones (partials) which are at or close approximations of even multiples of the fundamentals. In psychoacoustic terms, a note perceived to have a single distinct pitch, even though it is constituted by a superposition of overtones. However, inharmonicity arises when the frequencies of overtones (also known as partials or partial tones) substantially depart from whole multiples of the fundamental frequency (harmonic series).

In particular, many percussion instruments, such as cymbals, tam-tams, and chimes, create complex but inharmonic sounds.

On the other hand, the musical harmony and intonation of other classes of instruments depends strongly on the harmonicity of tones. In the case of stringed instruments such as the piano, but even more particularly in the case of violins, guitars and the like, the overtones are very close to—or in some cases, quite exactly—whole number multiples of the fundamental frequency. Even minor variations between harmonic and inharmonic sounds in these harmonic instruments are very important aspects of the instrument's timbre—where their frequency dynamics are predominantly harmonic stationary spectra, (as distinguished from the inharmonic time-varying spectra of gongs, timpani, bells or the like). As a result of this fundamental distinction between inharmonic and harmonic instruments, aspects of the present invention are particularly significant in affecting the timbre of the latter. Important aspects of the harmonic musical experience depend on those characteristics and an instrument's ability to reliably perform in solo performances as well as in orchestrations thereof.

Given the importance of a harmonic instrument's musicality in general it is also the case that instrument-to-instrument variations in such musicality may be particularly significant for composers, performers, and for audiences—all of whom have critical expectations for an instrument's musical production.

Sound boards are especially important components in these musical instrument chassis. This may be the case in solid body instruments, but it is particularly so in the case of hollow-bodied instruments wherein an enclosure compounds the acoustic manifestation of the sound board's interactions. They may profoundly influence the acoustics and psychoacoustic experience associated with an instrument's musicality and are often a primary influencer of the overall perception of the instrument's resonances and other timbral characteristics.

In particular however, aspects of the present inventions may relate to sonorous metal soundboards, and particularly to guitars, including acoustic guitars, but most especially electric guitars and even more specifically, to electric guitars having metal soundboards, and especially sonorous metal soundboard die castings.

Exemplary embodiments of aspects of the present invention may include guitars, which typically comprise a chassis including, inter alia, a headstock, a body, and a neck interposed between and mutually conjoining the headstock to the body.

The guitar body 1 and more particularly the soundboard 2 thereof (surrounded by integrally cast depending side wall 2a) is the primary acoustic resonator of the instrument.

Generally, other features of a guitar may include: an upper and lower bout, a cutaway, and provision for at least one bridge as well as pickups in the case of electric guitars. An upper bout is the part of the guitar body that is generally nearest the neck. The lower bout is the largest part of the guitar body that is generally nearest to the string terminus at the bridge. The cutaway (most often associated with electric guitars) is a gap formed between at least one side of the neck and an adjacent portion of the body and allows a performer to more easily position their hand within the gap between the body and the neck, to reach the “highest” frets positioned in supported relation on the neck.

A headstock supports tuning machines (which may be simple pegs friction fitted into corresponding friction-engaging holes in the headstock—but more typically are more complex mechanisms comprising graspable keys with associated shafts and gear assemblies. In either case, these tuning machines also include a reel to which one end of a corresponding guitar string is engageable, and which can be selectively tensioned through operation of the key (with the opposing end of the string anchored in spaced apart relation elsewhere on the guitar) to tune the string to a desired fundamental resonant frequency. The number of such machines and their arrangement on the head vary: e.g. with six machines for a typical six string guitar, and these are typically arranged either on opposing sides of the head, or in a linear array along one side of the neck, or even in slots within the neck.

A guitar nut is arranged at a location generally intermediate of the headstock and the neck—where it serves to support and separate individual strings at one end of the span of strings extending down the neck to its termination at a soundboard-mounted bridge. Nuts are often made of insert materials such as bone, plastics, stone or the like, but may be integrally formed in the head or neck in accordance with other embodiments hereof.

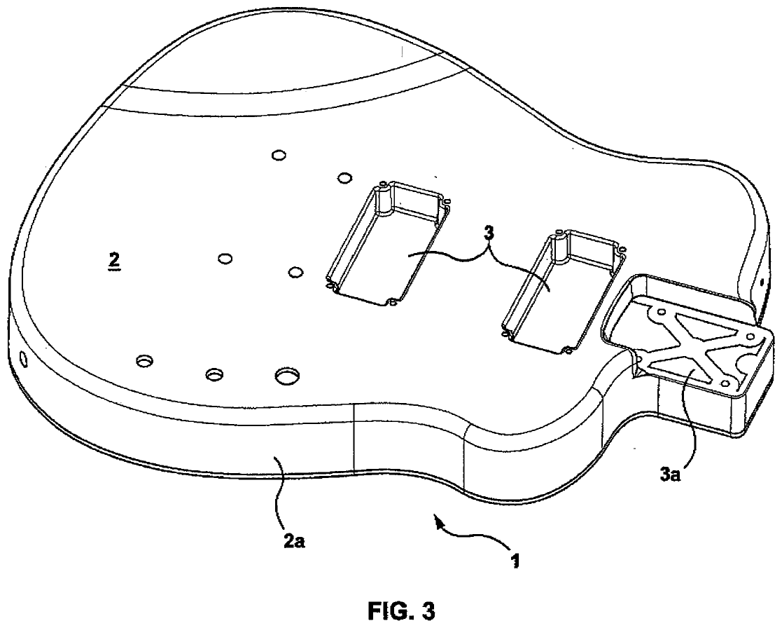

Similarly, embodiments hereof may include a guitar neck which is integrally formed with either the headstock, the body, or both. Alternatively, the neck may be attached using various jointed constructions, such as a fastener mediated (bolts or screws) interface, or “set-in” or “neck-through” joinery (see for example recess 3a on FIG. 3). Integral formation is associated with superior sustain, while the set-in or neck-through joinery is associated with intermediate sustain—and with mechanical fasteners being associated with less sustain.

In some guitar constructions, the headstock may also provide access to and adjustment of a neck truss rod, which may typically run longitudinally along (and usually internally of) the guitar's neck. The truss rod's role is to increase or relieve longitudinal bowing of the neck—e.g., in the case of wood necks which are particularly susceptible to temperature and humidity distortions. Structural bowing is a generally undesirable source of variation of the string to fret clearance distance—particularly when that bowing results in the string vibrating into unintended contact with the fret and causing fret buzz. Intonation and playability may also be affected by the truss rod adjustment.

The neck provides support for what is referred to as a fretboard (also known as a “fingerboard”) on which frets (typically in the form of raised, transverse metal bars) are arranged in mutually spaced apart relation along the longitudinal extent of the neck. During play of the instrument, a performer depresses the string suspended between the nut and the bridge, to selectively bring the string into contact with a fret, and thereby create an associated musical note (or combination of notes of a musical chord). The role of the neck as a resonator is typically secondary to the soundboard, but it is otherwise an important element of the overall acoustic circuit mentioned previously.

Bridges include saddles for receiving and holding the strings in mutually separated relation proximate to the juncture of the bridge and the soundboard. When a string is plucked (with or without a pick) or strummed, the imparted and returning vibrations transfer through the saddle, then through the bridge, and into/through the soundboard. As with so many aspects of the instrument, the bridge's location on the soundboard has an influence on the feel, tone, and intonation of the guitar.

In some cases, soundboards may include holes such as those which are most typically but not exclusively associated with acoustic guitars where, by way of example, a resonant hollow body enclosure tends to enhance lower frequencies produced from the strings to project through the sound hole, while the soundboard surface is more strongly associated with mid and high frequencies. Reflex ports such as sound holes may be arranged off-centre of the body, and may be variously shaped (e.g., circular or as an f-hole).

Soundboards also often provide location indexing, mounting and support for other components of the instrument. For example, one or more pickups (signal transducers) may be variously located on a soundboard (typically at locations in between the neck and the bridge) and in electric guitars these may include a plurality of pickups (with one, two, or three pickups, for example). Placement of the pickup plays a part in the instrument's acoustics and psychoacoustics. Pickups placed close to the bridge (the bridge or lead pickup) will sound bright and chimy; whereas pickups located closer to the neck (variously referred to as a neck, rhythm, or jazz pickup) will sound warmer with lower tone content (e.g., more bass). Single and double coil pickups may be used, with the former providing thinner and brighter sounding guitars, and the latter being associated with fatter and warmer sounds. Double coil pickups are associated with less noise production (reduced hum) and may be referred to as “humbucker” pickups.

Additionally, switches may be provided on the instrument to select between one or more pickups (i.e., combinations of pickups) in multi-pickup instruments. Various other controls (volume, tone or the like) may also be included to selectively condition the pickup output signal.

Soundboards may include front-facing recesses integrally cast therewith to variously register pickups, switches of the like, in indexed accommodation for one or more of this diversity of components, as well as to facilitate indexed registration and mounting of a neck in embodiments where such is not itself an integral part of a soundboard die casting. Integrally-cast recesses 3 hereof do not introduce additional acoustic impedances which may otherwise be associated with post-casting mechanical joinery, adhesives or even soldering or welding of such component-accommodating recess structures onto the soundboard.

In this latter respect, integrally-cast features, including such recesses or other integrally-cast acoustic-function features associated with aspects hereof (interior walls and wall defining pockets, for example), may be similar to machined recesses or the like, but offer instead the advantage of not requiring large material waste production—e.g., in the case of a guitar sound body, the machining losses from a 125-pound billet of foundry milled aluminum.

Overall, musical instruments are complex acoustic transducers which, as exemplified in terms of the above-described guitar, may be subtly affected by many and often interrelated aspects of their structure and materials. Aspects thereof relate to musical instrument soundboards.

In accordance with aspects of the present invention(s) therefore, a soundboard's structure and materials are disclosed having importance related to the acoustics and psychoacoustics of the overall instrument, and while diverse aspects of the present invention(s) may find more general application, they are most relevant in their specific application(s) to the soundboard thereof.

Soundboard embodiments may further include the above mentioned integrally-cast auxiliary acoustically functional structures such as internally-depending soundboard walls 4, either functioning per se or as walls defining acoustic damping insert pockets 5.

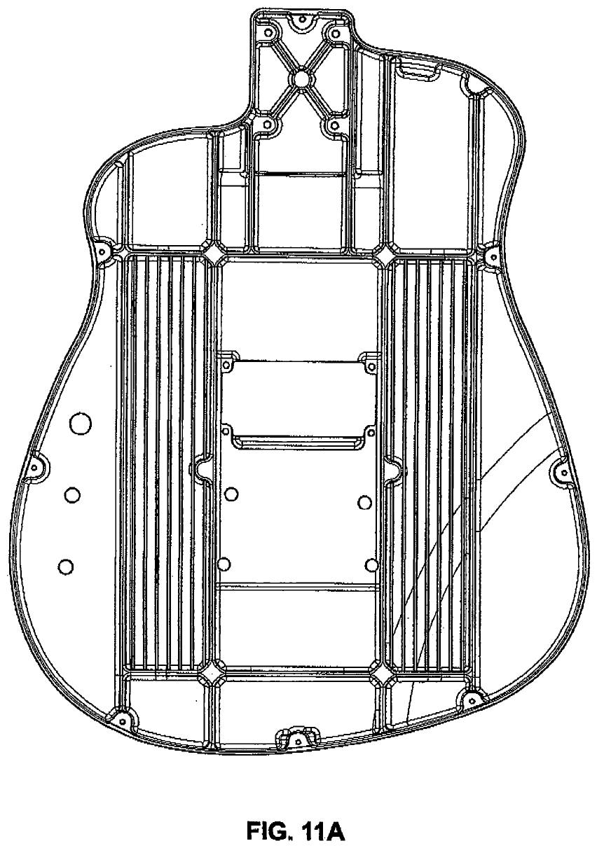

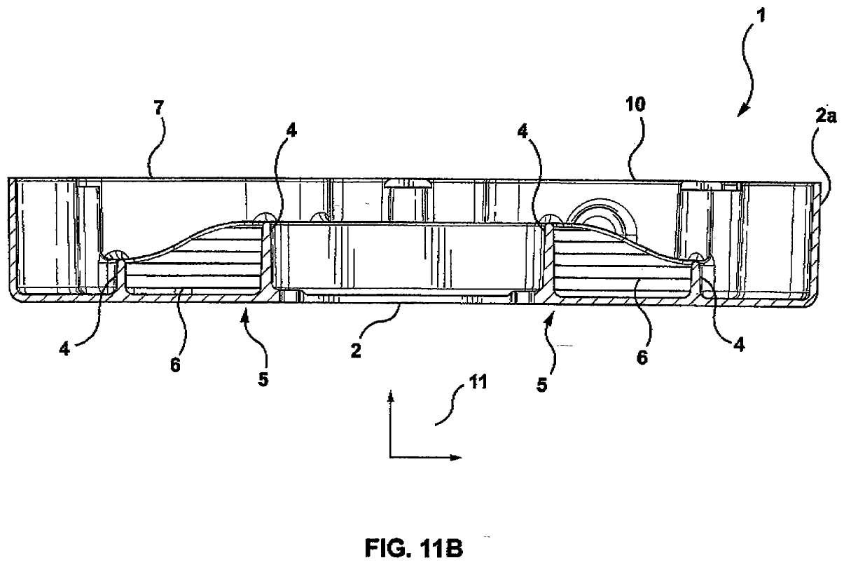

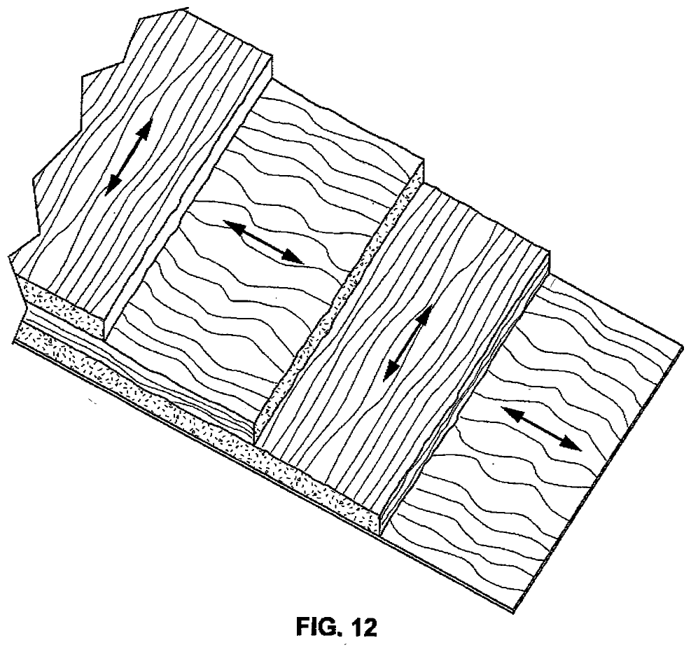

In either case, such dependent walls extend the soundboard's acoustic circuit outwardly on the backside of the soundboard, into the interior of the body.

Where adapted for use as pocket-defining walls 4 are arrayed on an interior (i.e., rearward side) of a soundboard these walls provide localized regions of an associated soundboard which are adapted for receiving damping inserts therein (see FIGS. 11 and 12). With the soundboard-to-wall as-cast impedance coupling, the acoustic coupling of the wall to a cooperating dampener insert is less subject to unintended mismatching. Such integral pockets may provide increased surface area for interfacing acoustic energy exchanges between a soundboard and an insert, whereby pocket-defining side walls can be acoustically coupled with damping insert peripheral edges.

Note again that the integrated casting avoids the introduction of acoustic artifacts otherwise associated with, for example, traditional joinery of ribs or the like to the soundboard.

Provision may be thereby made for the customizable insertion, (and if desired removal), of acoustic damping insert materials into and from pockets integrally-cast with an instrument's soundboard—which in turn affords end users the opportunity to selectively tune or otherwise affect timbre of their instruments to individual tastes and/or performances. For example, the selective use of such inserts permits selective customization of moderation/modulation of such characteristics as sustain and color. Additionally, groups of multiple instruments may be selectively/respectively tuned for cooperative orchestrations thereof through the selective and varied use of such inserts.

By way of example, aspects may relate to acoustic dampers which are dimensioned for insertion into a musical instrument having a metal acoustically resonant sound body. The dimensioning corresponds to complementary provisions of the sound body such that the acoustic dampener material seats into mutually abutted co-registration in an acoustically coupled hybrid sound body. Integrally formed pockets having side walls defining dampener receiving wells for accommodating acoustically coupled cooperatively shaped dampener material inserts in fitted registration therein may be variously located on the instrument body, and in particularly in accordance with the aspects of the present inventions(s), with the sound board thereof.

A musical instrument combination in accordance with the present invention(s) may include both a metal acoustically resonant sound body and at least one acoustic damping insert engaged in mutually abutted co-registration as an acoustically coupled hybrid sound body wherein musical instrument acoustic vibrations exchanged between the metal sound body and that insert's material are selectively dampened. For example, a compreg insert may be fitted into an integrally formed well, defined by surrounding walls of an integrally formed pocket defined by walls arranged in dependent relation on an interior face of the soundboard of an electric guitar. Inserts may be variously adapted and positioned so as, for example, to have an abutting face or portions thereof acoustically coupled in direct physical engagement against the soundboard (or alternatively, air-gapped in spaced relation therefrom); and/or, to have with the insert's peripheral edges coupled with (between opposing ones of) pocket defining walls. This latter arrangement provides direct acoustic coupling across the insert between peripheral edges thereof through a direct physical acoustic circuit connection by the insert between opposing walls of the pockets.

Aspects of the invention(s) further relate to damping inserts for selective damping when employed in combination with soundboards in a musical instrument's circuit—and more particularly for selective use as pocket inserts in association with the above-mentioned soundboard pockets.

Multiply veneers arranged as cross-grained laminates thereof are useful as pocket inserts, for offsetting the acoustic anisotropic effects of individual veneers—particularly in offsetting the anisotropy of the individual veneers relative to the isotropy of the metal body at the pocket wall coupling between the laminate edges and the those pocket walls.

Dampers herein may also include wood having altered lumen-affected wood grain anisotropy—“altered” through supplanting lumen void spaces with resin infusions and/or through compacting lumen voids by structural compaction of the wood. These physio-acoustic altered wood dampers (i.e., acoustic regulators) are characterized by correspondingly increased density, stiffness (e.g., especially Young's Modulus in the case of resin-infused lumen voids), increased speed of acoustic wave propagation, altered acoustic wave reflection/absorption/transmission from and into direct acoustic coupling interfaces with metal sound boards. The greatest impact of the alterations may manifest along the cross-grain direction of the constituent wood.

Preferably the wood damper is comprised of wood veneers laid out in a multi-ply composite, and especially preferred are embodiments comprised of cross-laminated plies with adjacent veneers having alternating grain directions—useful for correspondingly distributing the anisotropic variations of the wood's acoustic wave propagation characteristics.

In any case, the acoustic effects of altered woods as dampers in accordance therewith are more uniform because of the alterations, and as detailed hereinbelow, have desirable acoustic impedance matching characteristics for applications involving direct acoustic couplings with metal sound boards hereof.

Altered wood dampers herein have a density of greater than 0.70 g/cc—and preferably greater than 0.90 g·cc—as opposed to typical plywood (birch plywood with a density of 0.680 g/cc; mixed plywood having densities of about 0.620 g/cc; and conifer plywood having densities in the range of about 0.460 to 0.520 g/cc. Densities in the range of 0.94 to 1.4 g/cc are preferred—with lower densities in this range being associated with warmer tones than the higher densities—but with dampers hereof better approximating metal sound board densities (e.g. Al at 2.7 g/cc) and thus avoiding excessive acoustic reflection along directly coupled interfaces between the wood dampener composite and the metal sound board, (with concomitant acoustic impedance matching and capture of the brighter more sustained tones of the metal sound board while tempering that with the lower sustain and warmer tones contributed by an anisotropically-compensated wood dampener). Given that wood cell wall material typically has a density of about 1.5 g/cc: altered wood dampers hereof preferably have lumen void altered densities of greater than half that cell wall material density, and preferably greater than 60% thereof, including 70%, 80% and 90 to 95% thereof.

“Altered” wood plywood herein (i.e., with infused and/or compacted lumen voids) refers to:
Impreg cross-laminated wood veneer products having densities in the approximate range of 0.94 to 1.04 g/cc;
Compreg cross-laminated wood veneer products having densities in the approximate range of 0.95 to 1.4 g/cc; and,
Staypak cross-laminated wood veneer products having densities in the approximate range of 1.25 to 1.4 g/cc.

Impreg wood veneer products are primarily “altered”, in the sense hereof, through the infusion of resins into the wood cell lumen. Compreg involves both resin infusion and void compression alterations. Staypak on the other hand, is primarily a compression altered lumen wood material, wherein the compacted composite approaches the density of the cell wall material itself (i.e., about 1.5 g/cc) because of the compaction of the wood's lumen voids).

Still other aspects of the present invention relate to problems associated with the variability in musical instrument tone woods employed in soundboards, (both between and within wood species); such variability is a natural part of tree growth and introduces corresponding uncertainty into the reproducibility of instrumental musical qualities. This unresolved “botanical” and organic variability has for centuries predicated the frustration of manufacturers and musicians alike who continue to be faced with practical limitations of intrinsic wood characteristics (e.g., arising from the variability in orientations and proportions of cellular lumens and walls, etc.) to provide a controlled basis on which to design and construct musical instruments. Accordingly, there remains an unfulfilled need in the musical instruments art for selectively modulated musical instrument materials.

Such aspects relate to as-cast sonorous metal musical instrument die castings having selectively-diecast-metallurgy-affected timbre, to provide alternatives to traditional tone wood musical instrument constructions. Specifically applied-pressure/cooling-mitigated diecast metallurgies selectively affect instrumental musical qualities, and particularly timbre-modulating characteristics of as-cast sonorous metal die cast musical instruments. Methods for controlling musical instrument timbre of sonorous metal die castings' as-cast metallurgy in musical instrument die casting production, and diecast musical instruments/components having selectively diecast-affected timbre with corresponding modulated microintonation upscaling, damping sustain etc.

A musical instrument's diecast metallurgy may be specifically affected by applied cavity/injection pressure affected grain boundary surface area or relative density of cooling affected grain boundary surface area. Casting pressure or cooling applications respectively increase a proportionate response in the musical instrument diecasting's metallurgical relative density and the grain boundary surface area with corresponding timbre effects manifesting from altered impedance (and associated wave reflection transmission absorption), Q damping, wave propagation speed, micro-intonation scaling etc.

Aspects according to the present invention relate generally to sonorous die cast musical instrument soundboards resulting from injecting the metal into a multi-part mold comprising a pair of complementary cooperating die halves (typically tool steel dies). The mould's complimentary dies define a “negative” casting-shaped cavity therebetween, with the cavity corresponding to the desired dimensioning of the desired soundboard casting. These dies are mutually secured to the fixed and moving platens of the casting machine during the die casting process by mechanical clamps. The force required to press the die pair together during the injection of the molten metal is commonly rated in terms of clamping tons and is often called the clamping force.

The complementary dies of such moulds may comprise two dies: a “cover die half” and an “ejector die half” which are adapted to interface cooperatively along their respective parting line faces. A cover die typically contains either a sprue (for hot-chamber machines) or a shot hole (for cold-chamber machines), which allows the molten metal to flow into the mold, and in their respective cases, these are mated with the injector nozzle (of a hot-chamber machine) or to a shot chamber in a cold-chamber machine. The ejector die half contains the ejector pins and typically also includes a runner, which provides a path from the sprue or shot hole to the mold cavity.

The cover die is secured to the stationary, or front, platen of the casting machine, while the ejector die is attached to the movable platen.

A mold cavity typically accommodates complementary cavity inserts, which are separate pieces that can be replaced relatively easily and bolt into respective ones of the die halves. Other die components include cores and slides. Cores are components that usually produce holes or openings, but they can be used to create other details as well. There are three types of cores: fixed, movable, and loose. Fixed cores are ones that are oriented parallel to the pull direction of the dies (i.e., the direction the dies open), therefore they are fixed, or permanently attached to the die. Movable cores are ones that are oriented in any other way than parallel to the pull direction. These cores must be removed from the die cavity after the casting solidifies, but before the dies open, using a separate mechanism. Slides are similar to movable cores; except they are used to form undercut surfaces. Loose cores, also called pick-outs, are used to cast intricate features, such as threaded holes. These loose cores are inserted into the die before each cycle and then ejected with the casting at the end of the cycle. Other features in the dies include water-cooling passages and vents along the parting lines.

Typically, the dies are designed so that the solidified casting will slide off the cover half of the die and stay in the ejector half as the dies are opened. This assures that the casting will be ejected every cycle because the ejector half contains the ejector pins to push the casting out of that die half. The ejector pins are driven by an ejector pin plate, which accurately drives all the pins at the same time and with the same distribution of forces, so that the die casting is not damaged. The ejector pin plate also retracts the pins after ejecting the casting to prepare for the next casting cycle.

Methods employed for introducing the selected molten metal into a mould may include hot and cold chamber methods, with the selection between them being typically based on the melting point of the metal being cast. Hot chamber machines are primarily employed for zinc (in most cases), copper, magnesium, lead and other low melting point alloys that do not readily attack and erode metal pots, cylinders and plungers associated with a die casting machine. The injection mechanism of a hot chamber machine may be immersed in the molten metal bath of a metal holding furnace. The furnace channels the melt to the machine by a metal feed system sometimes referred to as a “gooseneck”, into an injection cylinder. Movement of an injection cylinder plunger causes a port in the injection cylinder to open, admitting molten metal in to fill the cylinder. As the plunger reverses its transit within the cylinder it seals the port and delivers molten metal through the gooseneck, into an injection nozzle and from there into the mould cavity defined between the die components. After the metal has solidified within the mould cavity, the plunger is withdrawn, the mould opens, and the die casting is ejected. Cold chamber machines are used for alloys such as aluminum and other alloys (e.g., certain zinc alloys (with a large composition of aluminium), magnesium, and copper), with high melting points. The molten metal is delivered to a “cold chamber,” or cylindrical sleeve, from a metal melt from a furnace. Then a precise amount of molten metal is transported to the cold-chamber machine where it is fed into a typically unheated shot chamber (also known as a shot sleeve). This molten “shot” is then introduced into the mould by a hydraulic or mechanically actuated piston (which consists of an injection cylinder and shot rod) followed by a plunger that seals the cold chamber port.

In accordance with aspects hereof, the negative cavity and the dies comprising the mold may provide for the overall dimensioning of the soundboard casting, as well as including provision for the walls and pockets referred to hereinbefore.

Aspects also may relate to musical instrument soundboard die castings which are particularly metallurgically-conditioned to affect acoustic and psychoacoustic qualities of the castings.

Metallurgical-conditioning aspects of the soundboards of the present invention may include cross-sectional stratifications across the width of the soundboard—having substantially differing grain size distributions associated with respective ones of the strata. Grain herein refers to a region within the solidified sonorous metal of the soundboard, wherein the crystalline structure of the atoms is relatively perfect, and the entire structure consists primarily of such grains. Metal grains are formed by growing larger from change joining of atom pairs or from an impurity or chemical agent—and as the grains grow in the metal's solidification from the melt, they meet one another, and the crystalline structure ends as these boundaries. Grain structure overall is often characterized in the art as fine or coarse, both of which refer to the size and shape of the grain in a metal. The degree of grain refinement during solidification causes grains to variously form specific sizes and shapes and is typically affected by the cooling rate. More particularly, such moulding is adapted for aspects of the present invention to provide a cross-sectional stratification of grain size distributions including fine grain peripheral strata (located along the front and back faces of the (e.g. aluminum) soundboard), in the range of about 0.4 to 0.5 mm in thickness each and bounding therebetween an intermediate coarse grain stratum having a predetermined thickness corresponding to a desired peripheral-to-intermediate cross-sectional stratum thickness ratio for selective differential attenuation of wavelengths of acoustic waves channeled along respective strata. The soundboard cross-sectional strata structures collectively provide for a sort of multi-channel path for acoustic wave propagation. The respective strata with their associated grain size distribution differences, are collaterally associated with correspondingly mutually differing damping characteristics, including relative amplitude and frequency attenuation. The strata are differentially formed during the transition of the melt from the liquidus to solidus states—during which rapid post-injection transition of the peripheral strata due to rapid heat loss manifests as a fine-grained solidus which is sharply demarcated from the slower transition (with heat loss therefrom being moderated through the more rapidly formed peripheral strata) and its substantially coarser grain structure.

According to an aspect of the present invention, the predetermination of the overall thickness of the soundboard, can be done to selectively achieve a relative ratio of the width of the coarse grain intermediate stratum to the fine grain peripheral strata which bound it—with the resulting overall soundboard acoustic wave impedance characteristics corresponding at least in part to the fine to coarse grain cross-sectional ratio.

Another aspect of metallurgical-conditioning of a musical instrument soundboard casting of sonorous metal relates to as-cast absolute pressure-mediated metallurgies which may provide acoustically modulated soundboards having corresponding as-cast pressure-mediated relative density. Aspects thereof include metallurgy affected by: pre-injection mould cavity pressures of less than 100 kPa, and preferably between 5 to 90 and preferably 5 to 80 and preferably 5 to 20 kPa; or fluidus mould injection pressures of 10,000 kPa or greater, (and preferably in a range of 20,000 to 67,000 kPa); or both in tandem.

As-cast musical instrument soundboard castings having fluidus mould injection pressure mediated acoustically modulated metallurgy (i.e., absent pre-injection mould cavity pressure effects), may have a relative density of greater than 80% for fluidus injection pressures of 10,000 kPa or greater. Similarly, for fluidus injection pressures of 20,000 kPa or greater, relative densities may be 90% or greater and preferably approximate the range of 99% to 99.5% for respectively about 23,000 to 67,000 kPa.

As-cast musical instrument soundboard castings further including in tandem pre-injection mould cavity pressure effects may further increase the relative density by 9 to 10% or more (e.g., from 81% to 90% for fluidus injection pressures of about 10,000 kPa). Up to about 2% at 23,000 kPa; up to about 0.5% to about 0.02% over the corresponding range of about 23000 to 67000 kPa. Relative density is the as-cast percentage of the measured casting density as compared to the nominal density of the sonorous metal from which it is cast—and is useful as a metric for both acoustic homogeneity and acoustic impedance (with related impact on acoustic wave transmission, absorption, reflection, and their role in instrumental sustain, resonance, timbre, etc.

As-cast musical instrument soundboard castings may have a pressure-mediated metallurgy of level 3 or less, compared to ASTM E505 reference radiographs, and preferably of level 1 or 2.

Aspects of the present invention are based in part on the realization that die casting has been associated with uncontrolled acoustic degradation of as-cast sonorous metal's metallurgy and which in particular militates against its use in producing musical instrument resonant sound bodies or, if so used, compromises reasonable expectations for the timbrous quality of the instrument so produced. As a result, musical instrument manufacturers have instead resorted to machining and/or forging sonorous metals in order to more reliably reproduce metallic musical instrument resonant bodies and especially soundboards of an expected character. Both CNC machining and corrective forging have been adopted in the musical instrument art for this reason.

In accordance with aspects of the present invention therefore, there is provided a solution for employing pressure-mediation in injection die casting as an alternative to the shortcomings of machining or forging of musical instrument resonant bodies: in order to specifically address the problem associated with compromised acoustic sonority more generally associated with generic die casting, and in order to thereby provide improved and reliable quality in an as-cast musical instrument resonant bodies, both generally but also in particular relation to soundboards, e.g. as in the case of chordophones, wherein the application of CNC machining results in large raw material losses, and where corrective forging is also problematic.

A musical instrument comprising a sonorous metal resonant body injection die casting is provided, having a pressure-mediated as-cast timbre-modulating metallurgy. The as-cast timbre results from pressure-mediated relative density and pressure-mediated relative elasticity and from pressure-mediated interstitial boundary reductions which contribute to a reduction in acoustic compression/expansion (with a corresponding reduction in interference) and loss of momentum.

Metallurgical timbre herein refers to the constituent metallurgy's contribution to the musical instrument's overall timbre. Timbre in general, (and unless otherwise more explicitly or contextually restricted herein), refers to various aspects of an instrument's acoustic characteristics, including texture and the like, (and includes in particular the timbre associated with polyphonic complexity of musical instrument resonating bodies, such as chordophone soundboards). By way of example, metallurgical timbre-modulation herein may include: a pressure-mediated resonant frequency scaling of the resonant body; a pressure-mediated resonant body wave propagation speed; and, a pressure-mediated resonant body acoustic impedance. An instrument's overall timbre includes concomitant manifestations of such timbre modulations. Timbre modulation herein is variously important in relation to how an instrument renders a particular musical composition; in fulfilling a performer's expectations of how reliably a given instrument will perform relative to another one of the same instruments (i.e., how uniform a given instrument's quality is, and how uniform the quality between instruments of the same make and model may be); and, in relation to how a plurality of such instruments may perform in orchestrations thereof. In the musical instrument context timbre is sometimes expressed in psychoacoustic terms as tone colour or tone quality, or as texture in reference to a particular instrument, or to bright/dark, warm/harsh and other such terms) is the perceived sound quality of a note, sound or tone. Timbre distinguishes differences in instrumental sound production—and refers to instrumental characteristics which may enable critical listeners to distinguish between different instruments whether of different or the same types. Timbre herein generally includes the characteristics which make a particular musical instrument's sound differ from another even when reproducing the same note, and even in response to the same impetus. Critical listeners (e.g., experienced musicians) are able to distinguish between different instruments based on their varied timbres, even if controlled for fundamental pitch and loudness. The physical characteristics of sound that determine the perception of timbre include frequency spectrum and envelope and correspond to the physicality of the instrument, including at least in part the composition of the instrument's materials. Timbre may be defined as that attribute of auditory sensation which enables a listener to judge that two nonidentical sounds, (even when similarly presented and having the same loudness and pitch), are dissimilar—and also depending primarily upon the frequency spectrum, although secondarily also upon the sound pressure and the temporal characteristics of the sound. Timbre's “at least five major acoustic parameters” have been characterized by: range between tonal and noise-like sound characteristics; spectral and temporal envelopes (attack, decay, sustain, release; changes in either or both: the spectral envelope (sometimes referred to as formant-glide) and the fundamental frequency (aka. microintonation); and sound onset or prefix. The richness associated with a musical instrument timbre may be described in terms of a net effect of the number of distinct frequencies it produces—beginning with the lowest or fundamental frequency. The fundamental frequency may or may not be the most dominant frequency (most perceived), although the dominant frequency is always either the fundamental frequency or some multiple thereof. Overtones of the fundamental frequency may include harmonics and partials: with harmonics being whole number multiples of the fundamental frequency. Subharmonics may also manifest as whole number divisions of the fundamental frequency. Each instrument produces combinations of frequencies, including harmonics and overtones, with the sound waves of different frequencies and phases overlapping and combining (constructively and destructively), and with the resulting balance of these amplitudes representing a major factor in the characteristic sound (e.g., timbre) of each instrument. In accordance with aspects of the present invention, controlled-pressure-mediated metallurgy may include pre-casting cavity pressure mediated metallurgy; or elevated injection pressure mediated metallurgy—and preferably includes both for tandem effect, (with references to pressure herein being absolute pressures) to affect the timbre related metallurgy of the injection die casting. In relation to musical instruments hereof, sonorous and sonority are references to metallurgical properties. Sonorous metals (i.e., metal elements and alloys) are characterized by a lesser number of electrons in their outermost orbital—resulting in highly delocalized electron bonding which is associated with the very low electronegativity of such metals. The more electronegative the metal, the more responsive it is to acoustic impulses, which may more easily displace the metal's electron cloud with relatively little energy dissipation. The resulting acoustic wave propagates at a wave velocity which is subject to the metal's elasticity and density, and the impedance is the product of the velocity and the density. For a given metal having a corresponding nominal density, die castings thereof lacking the as-cast pressure mediated metallurgy hereof, have a lower relative density, a reduced relative elasticity, and corresponding variations in timbre and the like. Controlled application of pressure to produce a desired as-cast metallurgy permits reliable control over the timbral characteristics of the musical instrument resonant body injection die casting.

Pre-casting injection cavity pressure-mediated as-cast timbre-modulating metallurgy is manifests primarily in the absence or at lower ranges of elevated injection pressure-mediated affected metallurgy—while over higher ranges of applied elevated injection pressure-mediated affected metallurgy, elevated injection pressure mediation tends to predominate both in affected metallurgy and in terms of corresponding as-cast timbre modulation of musical instrument resonant bodies. Pre-casting cavity pressure mediated metallurgy herein refers to injection die casting metallurgy resulting from at least some pre-casting cavity pressure-mediation; at least pre-casting cavity pressures of less than 100 kPa; and preferably less than 80 kPa; and pre-casting cavity pressures in the range of from 80 to 5 kPa or less.

Elevated injection pressure-mediated metallurgy in injection die castings manifests in the range of about 7,000 kPa to 100,000 kPa or greater, (7,000 to 35,000 kPa for hot chamber castable sonorous metals and about 10,000 kPa to greater than 100,000 kPa for cold chamber castable sonorous metals. When employed in tandem with pre-casting cavity pressures as mentioned above, the added timbre-related effect on the as-cast metallurgy of the resonant body is most significant for elevated injection pressure-mediated metallurgies affected at about 21,500 kPa (e.g., between 20,000 and 23,000 kPa) or less.

The sonorous metals (e.g., elemental metals or more typically metal alloys) may include hot chamber injection die castable and cold chamber injection die castable metals. Cold chamber injection die castable sonorous metals typically have higher melting points (with a rule of thumb of 540 degrees C. or higher), and with examples including metal alloys of brass and copper, and preferably much lower density metals such as Al. Less typical cold injection die castable sonorous metals may have lower melting points—such as ZA27, a zinc aluminum alloy having a melting point of 431 degrees C. Exemplary Al alloys (melting points in degrees C.), include: A380 (566); A383 (549); B390 (578); 413 and A413 (578); K-Alloy (680); and A360 (577). Hot chamber injection die castable sonorous metals include other alloys of zinc or alloys of magnesium, typically having lower melting points (below 540 degrees C.). Examples may include MG AZ91D (533); Zinc Zamak alloys 2, 3, 5, 7 (384-385); ZA8 (390) ACuZinc 5 (452); and EZAC (396). Cold chamber injection die castable sonorous metals are generally preferred for musical instrument resonant body pressure-mediated die castings aspiring to relative densities of 99% or greater, (relative density herein being the ratio of the volumetric density of the as-cast resonant bodies sonorous metal to the nominal density of that metal). Hot chamber injection die castable sonorous metals are not generally associated with elevated injection pressure-mediation above about 35,000 kPa.

Estimated metallurgically affected acoustic performance of as-cast pressure-mediated injection die castings (for reported cold chamber AL A380 samples), and using relative density as a proxy therefore.

| | |
|---|---|
| Elevated injection | Pre-casting injection |
| pressure-mediation | cavity pressure-mediation |
| (approx. elevated injection | over a range of: |
| pressure in kPa) | 100 kPa to 5 kPa |

| | | |
|---|---|---|
| 10,000 | 40% | 90% |
| 20,000 | 97% | 99% |
| 21,500 | 98% | 99% |
| 23,000 | 99% | 99+% |
| 27,000 | 99+% | 99+% |
| 45,000 | 99+% | 99+% |
| 56,000 | 99+% | 99+% |
| 67,000 | 99+% | 99+% |

Musical instrument resonant bodies herein may include soundboards, and in particular chordophone soundboards which may impact the subtleties of their timbre and are not generally amenable to post-casting metallurgical correction.

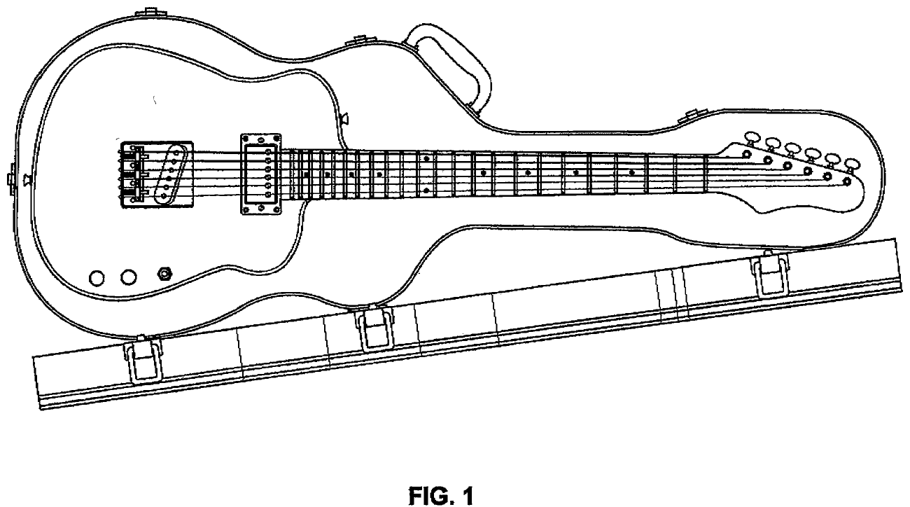

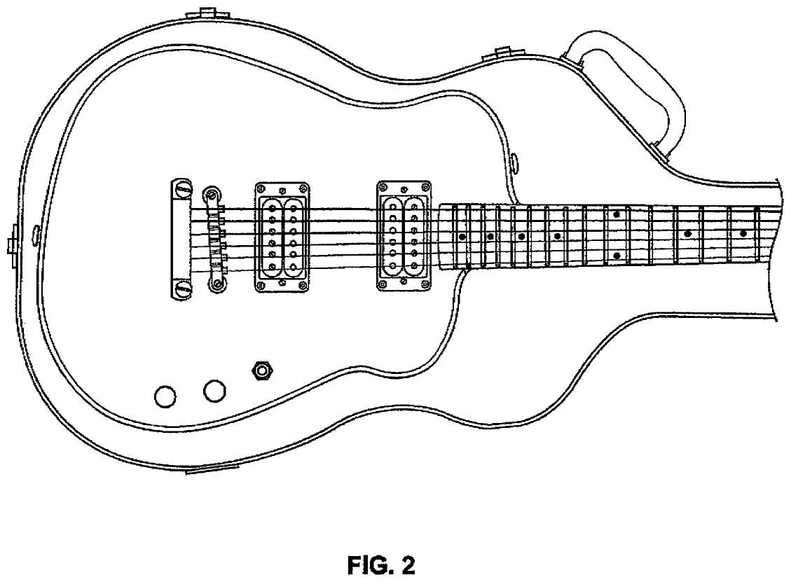

Referring now to the appended drawings, FIGS. 1 and 2 show illustrative designs of hollow-bodied electric guitars having metal (aluminum) resonant bodies. FIG. 2 illustrates a double pickup arrangement, as an example of the earlier described humbucker guitars.

Referring now to FIG. 3, there is shown a perspective view of side and front walls of a sound board die casting, without the pickups and controls in place, and illustrating a recess for receiving a bolt on neck.

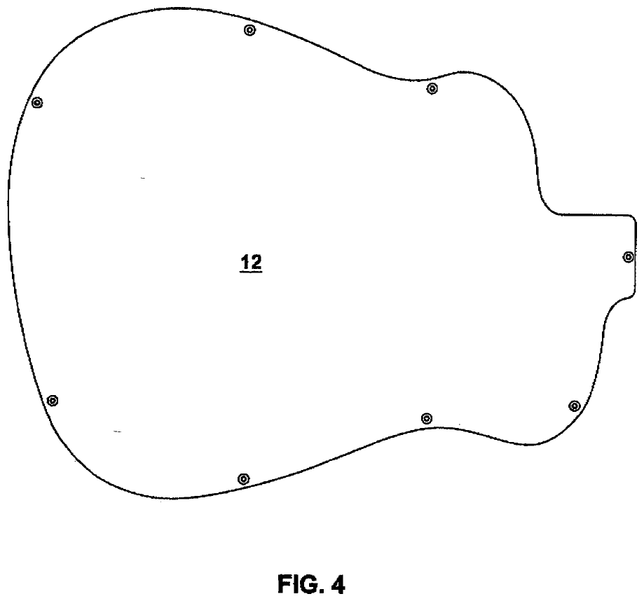

FIG. 4 shows a rear panel for attaching to the back of the die casting of FIG. 3 and which may function to enclose the hollow resonant body thereof. The rear panel 12 may be metal or some other material.

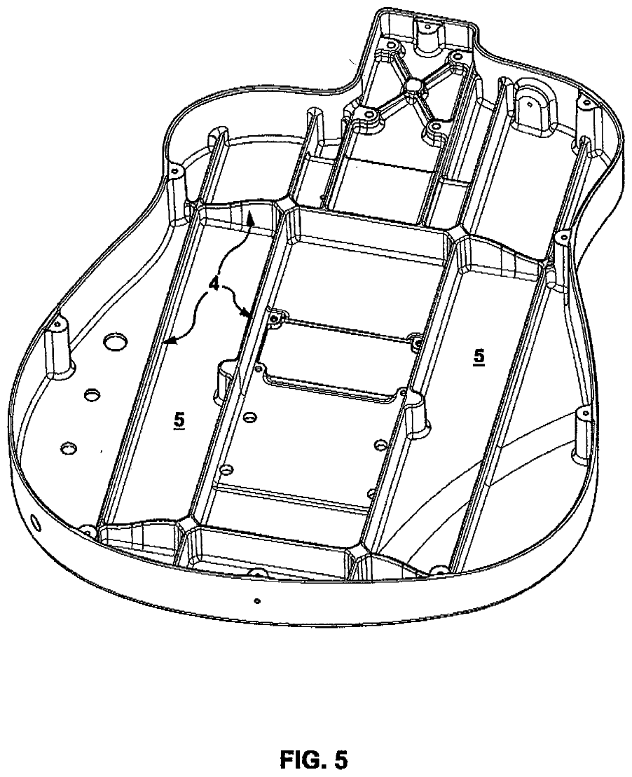

FIG. 5 offers an interior view of a hollow resonant body embodiment according to the present invention, particularly illustrating integrally cast interior structures, with examples thereof including pockets variously adapted to receive damping inserts therein—as described in greater detail in relation to FIGS. 11a, 11b and 12.

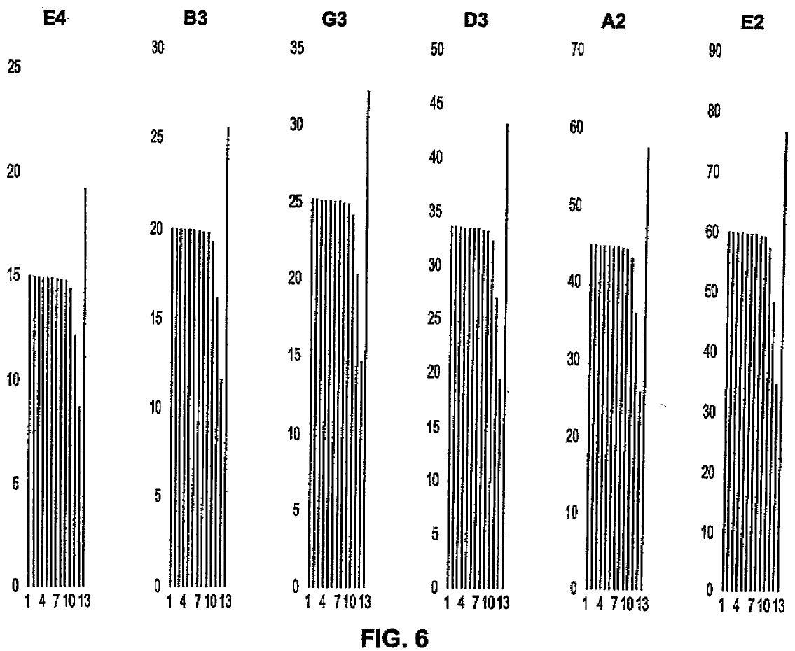

FIG. 6 presents a series of wavelength (in meters) histograms for each of respective ones of guitar notes E4, B3, G3, D3, A2 and E2. The wavelengths for the respective frequencies vary in relation to the as-cast densities for each of 12 aluminum alloy die casting samples as shown in the following table, and as compared to the nominal density of that alloy, per se.

| Reference # | Density in kg/m3 |
|---|---|
| Sample 1 | 2702 |
| Sample 2 | 2700 |
| Sample 3 | 2697 |
| Sample 4 | 2696 |
| Sample 5 | 2695 |
| Sample 6 | 2694 |
| Sample 7 | 2693 |
| Sample 8 | 2685 |
| Sample 9 | 2683 |
| Sample 10 | 2644 |
| Sample 11 | 2438 |
| Sample 12 | 2201 |
| 13 (nominal density of alloy per se) | 2740 |

With all other things being equal, the differing wavelengths associated with their respective metallurgical densities manifest mutually differing timbral qualities in the metal resonant bodies comprised of same. Accordingly, the selection of an as-cast resonant body die casting having a particular applied-pressure mediated density facilitates a corresponding selection of the timbral qualities contributed by the metallurgy of resonant body's metal constituency (i.e., with lower densities being associated with both shorter wavelengths at the same frequencies; and, with lower acoustic wave propagation speeds). Both effects are associated with lower acoustic impedance at these lower densities.

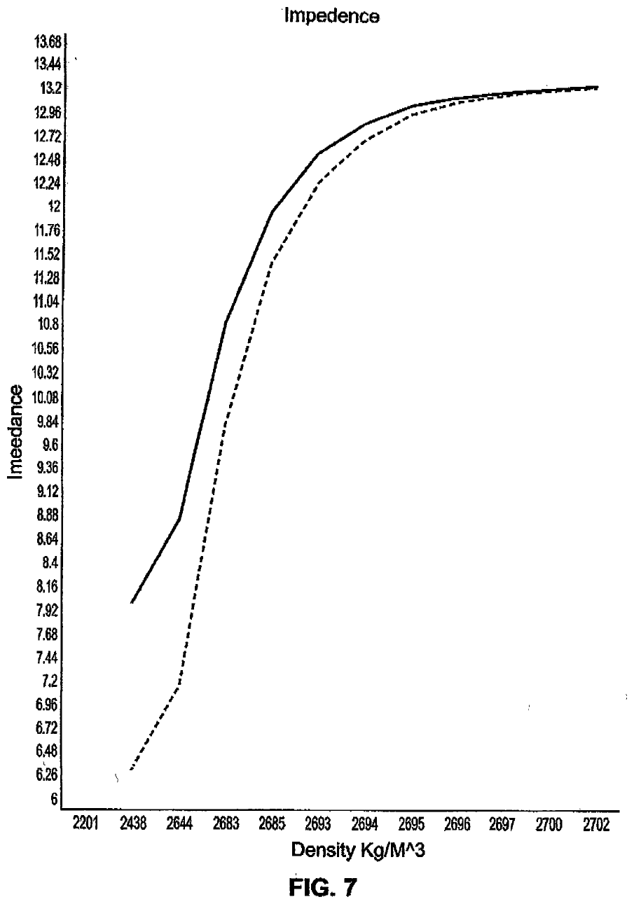

FIG. 7 graphically depicts this relationship between acoustic impedance (measured in Mryals) in relation to the as-cast diecasting's density (Kg/m3). The uppermost curve represents density affected by a combination of pre-casting injection cavity pressure mediation and applied melt injection pressure mediation—and the lower curve represents density affects associated with applied melt injection pressure mediation alone. The region between the two curves is representative of variations between applied pre-casting injection cavity pressures in the range of about 5 to 80 kPa absolute. Aspects hereof include methods for affecting impedance in musical instrument die castings variously employing one or more of applied pressure, grain refinement or combinations thereof.

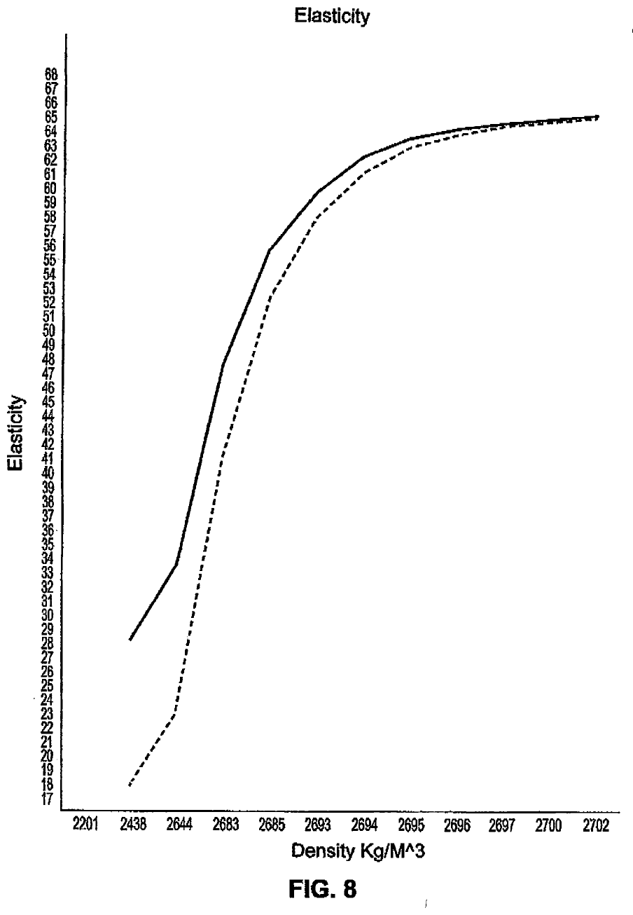

FIG. 8 of the drawings is a graphical representation of the relationship between metallurgical elasticity (GPa) and density (Kg/m3) of as-cast pressure-mediated acoustically-modulated die castings—again, with the lower curve representing the acoustic modulation affected by application of applied melt injection pressure alone; and, in the upper curve, in combination with applied pre-casting injection cavity pressure mediation. Also once again, the region between the two curves covers the above-mentioned range of applied pre-casting injection cavity pressures. The propagation of acoustic waves in the as-cast resonant body is a function of the constituent metal's elastic and inertial properties. More particularly in accordance with aspects of the present invention, as-cast applied-pressure-mediated metallurgical elasticity and density cooperate in the resulting acoustic impedance characteristics represented in FIG. 6. Acoustic impedance is a characteristic of the as-cast injection die casting itself, which characteristically affects the relationship between an acting acoustic impulse and the resulting velocity of the acoustic wave's propagation—thus affecting wave propagation speeds, the corresponding wavelengths for associated acoustic frequencies and both transmitted and standing oscillations—and hence contributes to a musical instrument's overall timbre.

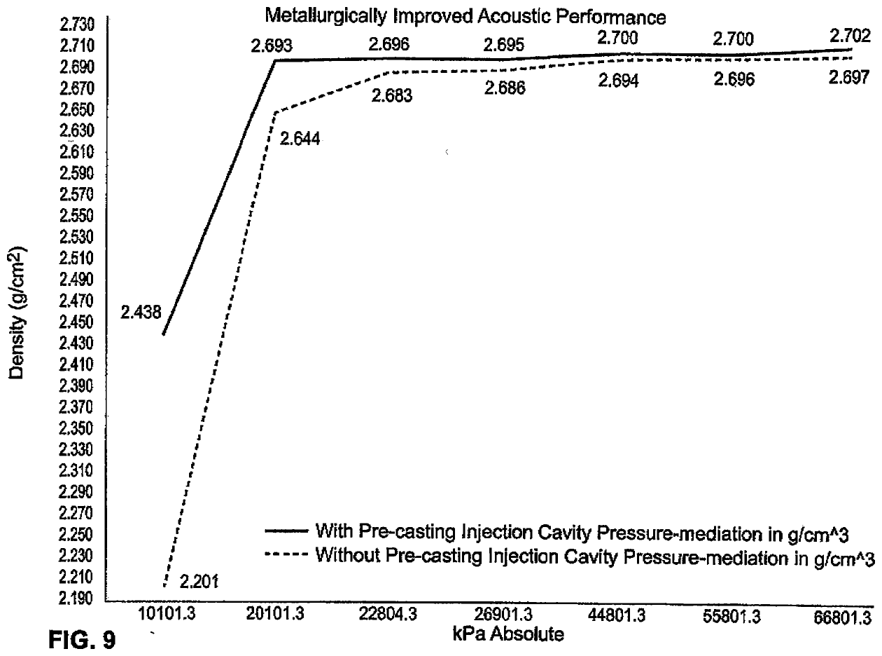

FIG. 9 of the appended drawings is yet another graphical representation (for an aluminum alloy), and in this case of the relationship between as-cast constituent metal of the injection die castings and the applied pressure mediation associated with acoustic-modulation of a musical instrument's timbre. As with FIGS. 7 and 8, the upper and lower curves correspond respectively to as-cast die castings with and without the application of pre-casting injection cavity pressure mediation (and with the cross-hatched region between the curves reflecting an associated range of applied pre-casting injection cavity pressure mediations). This graph helps to illustrate the proportion of the combined affect of applied pre-casting injection cavity pressures, over the lower portion of the range of applied melt injection pressures, which are attributable to the former when employed in such combinations—and its diminishing affect at the higher ranges of applied melt injection pressures. Moreover, the graph illustrates that while a larger range of affect of applied pressure mediated acoustic-modulation characteristics may be realized over correspondingly lower ranges of applied pressure regimens, the degree becomes progressively more subtle above 10,000 kPa absolute applied melt injection pressure and falls of even more substantially at about 20,000 to 22,000 kPa for these as-cast die castings. Note in this connection that for hot injection die casting metals, the applied melt injection pressures are typically in the range of about 7000 kPa to 34500 kPa (absolute), where the applied pre-casting injection cavity pressure affects are most significant. For cold injection die casting metals, those applied melt injection pressures are typically in the range of 10,000 kPa to >100,000 kPa (absolute).

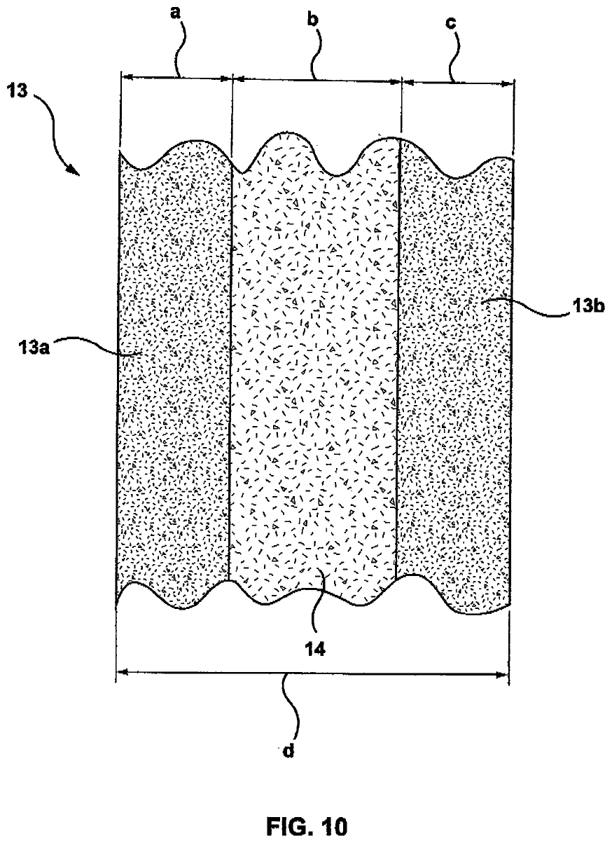

FIG. 10 of the drawings is a representation of a cross-section of an as-cast diecasting's wall to illustrate the discernable manifestation of layered small and large grain refinement across the width of a resonant body wall portion thereof. Aspects hereof further include the application of selective grain refinement through selection of thin wall resonant body dimensioning in conjunction with such gain refinement, resulting in related proportioning of peripheral fine-grained layers surrounding a coarse-grained core layer. Grain refinement contributes to the as-cast density both on average and through localization of higher peripheral layer versus core layer densities and associated collateral affects on instrumental timbre as an adjunct to other aspects of the present invention(s).

The cross-section illustrates a thin-wall section 13 having an overall thickness of “d”. Peripheral layers 13a and 13b have respective (typically equal) thicknesses of dimensions a and b respectively. Core layer 14 has a dimension b. The relationship between these various dimensions depends on the grain refinement affected fine grain constituency and the overall thickness of the wall 13. Thin walls of from 1 to 5 mm are contemplated, but walls of 2 to 4 mm are preferred—with the grain refinement affected timbre of the soundboard having a collateral synergistic effect in strengthening the walls while at the same time facilitating light-weighting of the soundboard to save on material costs and the weight a musician might have to carry.

In connection with aspects hereof, the number of grains is proportionate to increasing casting pressure affects on timbre and size of grains is inversely proportional to increasing applied pressure affects on timbre.

Additionally, peripheral cooling including passive heat loss to the die (but preferably includes active peripheral die cooling), to increases the thickness of small gain boundary proportions of the die castings cross-section as well as an overall increase in the number of small grains contained in the die casting as a whole.

Aspects hereof concern selective active thermal transfer to mediate heat transfer rates from the injected melt into the die, thereby selectively control both refined grain size/numbers but also relative thicknesses of the discernable core and peripheral layers.

In preferred aspects, the peripheral layers have a cross-sectional thickness of about 0.015 to 0.020″ (0.38 to 0.50 mm). Relatively, the fine-grained peripheral layers range in thickness from 15 to 99% or more of the overall cross-sectional thickness of the resonant body wall—with a corresponding core layer making up 85 to 1% or less thereof.

Having a ratio of skin to core of fine-grained skin-effect surrounding a coarse-grained core and where the thickness is about 1 to about 5 mm. Ratio of 1 to 0.76 to 1 or 100% skin for a 1 mm×section sound board with a 5 mm skin on both surfaces.

Active cooling may be selectively adapted to provide a core layer channel having a lower internal acoustic impedance relative to the peripheral layers which surround it, and thereby differentially affect the overall distribution of acoustic waves within the core of the instrument (affecting transmission and reflection between peripheral and core layers based on their differing impendences).

FIGS. 11a and 11b illustrate the combination of damping inserts 6 in engaged relation between wall structures 4 defining pockets 5, within the interior of the body 1.

FIG. 12 depicts a cut-away view of the layered plys of damping inserts previously detailed herein. The cross-grain lamination arrangement of the alternating anisotropic plys (7, 8, 9 and 10 with respective wood grain orientations 7a, 8a, 9a and 10a respectively), provide a damping insert edge 11 for mating in acoustically coupled relation with the isotropic metal of the internal wall structures 4 defining pockets 5.

1. A musical instrument resonant body comprising a sonorous metal die casting having a selected as-cast density of less than said sonorous metal's nominal density, thereby selectively providing relative thereto a correspondingly mediated harmonicity-modulated acoustic timbre.

2. The musical instrument resonant body according to claim 1, wherein said instrument is a harmonic or near-harmonic musical instrument having an as-cast density of at least 40% of said nominal density.

3. The musical instrument resonant body according to claim 1, wherein said as-cast density is an applied absolute pressure selected density; or, a refined grain mediated density, including for example an applied cooling thermally refined grain mediated density; or combinations thereof.

4. The musical instrument resonant body according to, claim 1 wherein said as-cast relative density is an applied absolute pressure mediated density, as for example an applied pre-casting injection mould cavity pressure mediated density or an applied melt injection pressure mediated density.

5. The musical instrument resonant body according to claim 1 wherein said instrument is a chordophone and especially a member of the lute family.

6. The musical instrument resonant body according to claim 5 wherein said instrument is a guitar, and either an acoustic or electric guitar or a combination thereof.

7. The musical instrument resonant body of claim 5 wherein said resonant body is a sound board.

8. The musical instrument resonant body of claim 7 comprising a hollow bodied sound board.

9. The musical instrument resonant body according to claim 8, wherein said body comprises an enclosed hollow-bodied soundboard.

10. The musical instrument resonant body according to claim 9 comprising an integrally cast monolithic sound board including a front face with surrounding edge-dependent side wall(s) partially enclosing a hollow-bodied interior space.

11. The musical instrument resonant body according to claim 10 comprising rear panel for engaging with the soundboard, to further enclose said interior space.

12. A method for modulating a musical instrument's resonant body die casting's as-cast acoustic impedance comprising the steps of selecting an applied (as opposed to passive), die casting forming pressure for mediating an as-cast applied pressure mediated metallurgy having a corresponding acoustic timbre modulation.
